(19) United States
(12) Patent Application Publication
(10) Pub. No.: US 2011/0019024 A1
(43) Pub. Date: Jan. 27, 2011

(54) APPARATUS FOR RECORDING AND REPRODUCING VIDEO IMAGES

(75) Inventor: Yusuke TANJI, Osaka (JP)

Correspondence Address: McDERMOTT WILL & EMERY LLP, 600 13th Street, N. W., Washington, DC, 20005-3096, US

(73) Assignee: PANASONIC CORPORATION, Osaka (JP)

(21) Appl. No.: 12/898,312

(22) Filed: Oct. 5, 2010

Related U.S. Application Data
(63) Continuation of application No. PCT/JP2009/001755, filed on Apr. 16, 2009.

(30) Foreign Application Priority Data
May 8, 2008 (JP) 2008-122054

(51) Int. Cl. H04N 5/917; H04N 5/225

(52) U.S. Cl. 348/222.1; 386/241; 386/E05.003; 348/E05.024

(57) ABSTRACT

When captured video image data are encoded and recorded in a recording medium as video image encoded data, a predefined action of an image pickup device is detected. Then, a cue position is determined on the basis of the predefined action thus detected, and a GOP structure is changed. Thus, the cue position can be determined without any instruction directly inputted by a user, and the GOP structure of the cue position can also be changed. As a result, any unnecessary data transfer can be omitted, and an image quality can be prevented from deteriorating in editing and reproducing the video image data.

### BACKGROUND OF THE INVENTION

1. Field of the Invention

The present invention relates to an apparatus for recording video image data, an apparatus for reproducing video image data, a method for recording video image data, a method for reproducing video image data, and a semiconductor integrated circuit suitably configured to record video image data, more particularly to a technology suitable for speedily accessing any desirable scene when the video image data is reproduced.

2. Description of the Related Art

There are diverse conventional apparatuses for recording and reproducing video images which are technically designed to quickly jump to a particular position in video image data or cue the video image data when the video image data is reproduced (for example, see the Patent Document 1).

The video image recording apparatus disclosed in the Patent Document 1 (hereinafter, simply called the conventional example) is provided with a bit rate researcher which researches a bit rate of video image data, and a chapter setter which sets a chapter in the video image data when the bit rate of video image data changes by at least a given value. In the conventional example, a position where the bit rate of video image data changes by at least the given value is reckoned as a scene which a user wants to view, and the chapter is then set.

### SUMMARY OF THE INVENTION

### Problem to be Solved by the Invention

Patent Document 1: Unexamined Japanese Patent Applications Laid-Open No. 2007-150528

### Prior Art Document

### Patent Document

In the conventional example, wherein the position where the bit rate of video image data changes by at least the given value is reckoned as a scene which a user wants to view to set the chapter, however, the scene wanted by the user does not always meet the position where the bit rate of video image data changes by at least the given value. Therefore, the chapter is not set in the scene wanted by the user but is set at any unwanted position in some cases.

Moreover, the conventional example, which was developed to record TV programs, is not particularly suitable as an apparatus for recording video images equipped with an image pickup device such as a digital video camera.

The present invention was carried out to deal with the conventional disadvantages. A main object of the present invention is to detect a scene which a user wants to view and set a chapter there based on a user's operation while the video image data is being recorded, thereby helping the user easily access any desirable scene when he reproduces the recorded video image data in a video image recoding apparatus equipped with an image pickup device such as a video camera.

### Means for Solving the Problem

To achieve the object, a video image recoding apparatus according to the present invention includes:

an image pickup device for capturing an image to obtain a digital video signal;

an image encoding processor for encoding the digital video signals for each GOP having a plurality of frames to generate video image encoded data;

a recorder for recording the video image encoded data in a recording medium; and

a cue position generator, wherein

the cue position generator includes:

a first processor for detecting a predefined action taking place in the image pickup device when the recorder is recording the video image encoded data in the recording medium; and

a second processor for instructing the image encoding processor to change a GOP structure in the video image encoded data on the basis of the predefined action detected by the first processor.

A large number of predefined actions of the image pickup device which generates the digital video signal which constitutes the video image encoded data take place in conjunction with a cue position of the video image encoded data. Focusing on the technical trend, the present invention, when a predefined action is detected in the image pickup device while the video image encoded data including the digital video signals is being recorded in the recording medium, changes the GOP structure at a data position where the detected predefined action took place (cue position). When such an additional data change is applied to the video image encoded data, the cue position in the video image encoded data in reproduction or editing can be accurately known in a short period of time. Then, the cue position in the video image encoded data can be defined without any particular instruction directly inputted by a user.

According to a preferable mode of the present invention, the second processor instructs the video image encoding processor to change the GOP structure in the video image encoded data from OpenGOP to ClosedGOP.

The technical characteristic according to the preferable mode makes it unnecessary to prepare a forward reference GOP in editing or reproducing the video image data. As a result, an image quality can be prevented from deteriorating, and any unnecessary data transfer can be omitted.

According to another preferable mode of the present invention, the image pickup device can adjust an imaging angle of view, and the first processor detects the adjustment of the imaging angle of view by the image pickup device as the predefined action.

The technical characteristic according to the preferable mode reckons the adjustment of the imaging angle of view as a scene wanted by the user, and then generates the cue position.

According to still another preferable mode of the present invention, the second processor instructs the image encoding processor to undo the GOP structural change in a certain period of time passes after instructing the image encoding processor to change the GOP structure.

The technical characteristic according to the preferable mode can improve an encoding efficiency by changing the GOP structure back to its original structure after the certain period of time passes. For example, the GOP structure is changed to ClosedGOP for a given period of time in response to the GOP structural change instruction, and then changed back to OpenGOP again after the given period of time passes.

According to still another preferable mode of the present invention, the second processor instructs the image encoding processor to generate a chapter display image or instructs the recorder to split the video image encoded data on the basis of the predefined action detected by the first processor.

As a result, the chapter can be generated at a position where the GOP structural change is instructed (cue position).

According to still another preferable mode of the present invention, the second processor instructs the image encoding processor to add information relating to the predefined action to the video image encoded data as additional information on the basis of the predefined action detected by the first processor.

As a result, the information relating to the predefined action can be added to the video image encoded data as additional information.

According to still another preferable mode of the present invention, the video image recoding apparatus further includes a sensor for detecting tilt of the image pickup device, wherein the first processor detects the tilt of the image pickup device as the predefined action on the basis of a sensor output obtained from the sensor.

In such an event that a camera currently rolling is accidentally pointed downward and capture the image of ground in a video image recording apparatus such as a digital video camera, the technical characteristic according to the preferable mode can define the cue position of the relevant scene on the basis of the detected predefined action, and then change the GOP structure. When the user later finds the scene unnecessary, he can easily delete the scene in editing the images.

According to still another preferable mode of the present invention, the video image recoding apparatus further includes a management information recorder for recording therein management information used to manage the video image encoded data, wherein the cue position generator further includes a third processor, and the third processor obtains information indicating a data position of the video image encoded data where the GOP structural change is made by the second processor from the recorder, and records the obtained information as the management information in the management information recorder.

The video image recoding apparatus thus technically characterized manages time information indicating the data position of the video image encoded data where the GOP structural change was made by recording the time information in the management information recorder, thereby enabling a quick jump to any wanted scene of the video image data or cueing the video image data in reproduction in the case where the chapter is not generated at the cue position.

A video image reproducing apparatus according to the present invention includes:

a reader for reading additional information of video image encoded data from a recording medium; and

a reproducer for reading the video image encoded data from the recording medium based on the additional information to reproduce the read video image encoded data, wherein

the reproducer determines whether information relating to a predefined action taking place when the video image encoded data is obtained is recorded in the additional information read by the reader, and the reproducer which determined that the information is recorded in the additional information can reproduce the video image encoded data from a data position defined as a position where the predefined action took place in the information.

As far as the information relating to the predefined action taking place when the video image encoded data is obtained is recorded in the additional information, the video image reproducing apparatus can reproduce the video image encoded data from the data position defined where the predefined action took place.

According to a preferable mode of the present invention, the video image reproducing apparatus further includes an editor which can set a data position in the video image encoded data where variation of an image characteristic quantity is at least a given quantity as a cue position in the video image encoded data.

The image characteristic quantity represents parameterized dimensions, positions, and relative positions of parts of a face such as eyes, nose and mouth that can be extracted from an image, and a face contour. For example, a person in a video image is recognized as a photographic subject using, for example such a conventional face detection technique that parts of a face having distinguishable shapes such as eyes, nose and mouth are searched in the video image at around a screen center to detect whether there is a high degree of similarity. Then, a scene involving the person can be set as the cue position.

A video image recording method according to the present invention includes:

an image capturing step for capturing an image using an image pickup device to obtain a digital video signal;

an image encoding step for encoding the digital video signals for each GOP having a plurality of frames using an image encoding processor to generate video image encoded data;

a recording step for recording the video image encoded data in a recording medium using a recorder; and

a cue position generating step, wherein

the cue position generating step includes:

a first processing step for detecting a predefined action taking place in the image pickup device when the video image encoded data is being recorded in the recording medium in the recording step; and

a second processing step for instructing the image encoding processor to change a GOP structure on the basis of the predefined action detected in the first processing step.

A video image reproducing method according to the present invention includes:

a reading step for reading additional information of video image encoded data from a recording medium where the video image encoded data including the additional information is recorded; and

a reproducing step for reading the video image encoded data from the recording medium based on the additional information read in the reading step to reproduce the read video image encoded data, wherein

the reproducing step determines whether information relating to a predefined action taking place when the video image encoded data is obtained is recorded in the additional information read in the reading step, and the video image encoded data can be reproduced from a data position defined as a position where the predefined action took place in the information when the reproducing step determined that the information is recorded in the additional information.

A semiconductor integrated circuit according to the present invention includes:

an image encoding processor connected to an external image pickup device, the imaging encoding processor encoding digital video signals for each GOP having a plurality of frames to generate video image encoded data;

a recorder connected to an external recording medium to record the video image encoded data in the recording medium; and

a cue position generator, wherein

the cue position generator includes:

a first processor for detecting a predefined action taking place in the image pickup device when the recorder is recording the video image encoded data in the recording medium; and

a second processor for instructing the image encoding processor to change a GOP structure in the video image encoded data on the basis of the predefined action detected by the first processor.

As described so far, the present invention can provide these apparatuses and methods. The present invention is further applicable to a program configured to make a computer run processing steps in functions and methods carried out by the apparatuses, a computer-readable recording medium in which the program is recorded such as CD-ROM, or information, data or signals constituting the program. The program, information, data and signals can be distributed through a communication network such as the Internet.

### EFFECT OF THE INVENTION

The present invention can effectively help a user access any scenes he wants to view when recorded video image data is reproduced in a video image recording apparatus equipped with an image pickup device such as a digital video camera, or a video image reproducing apparatus. Another technical feature of the present invention is to facilitate editing of the recorded video image data by changing a GOP structure thereof.

### BRIEF DESCRIPTION OF THE DRAWINGS

FIG. 1 is a block diagram illustrating a structure of a video image recording apparatus according to an exemplary embodiment 1 of the present invention.

FIG. 2 is a flow chart illustrating an operation flow of a cue position generator according to the exemplary embodiment 1.

FIG. 3A illustrates a structure 1 of GOP.

FIG. 3B illustrates a structure 2 of GOP.

FIG. 4 is a block diagram illustrating a structure of a video image recording and reproducing apparatus according to an exemplary embodiment 2 of the present invention.

FIG. 5 is a flow chart illustrating an operation flow of a cue position generator according to the exemplary embodiment 2.

FIG. 6 is a flow chart illustrating an operation flow of a reproducer according to the exemplary embodiment 2.

### BEST MODE FOR CARRYING OUT THE INVENTION

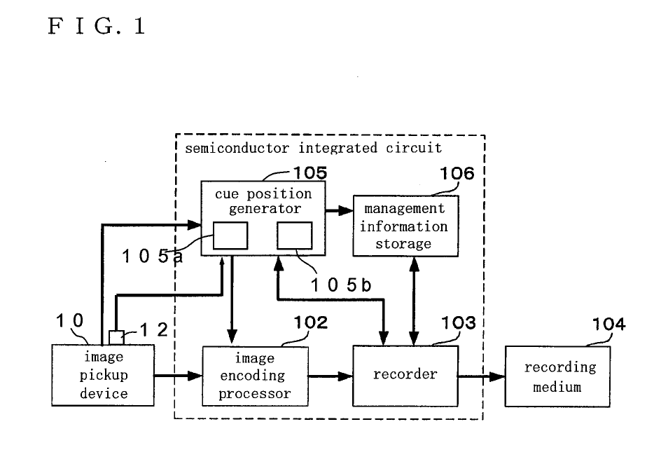

A video image recording apparatus according to an exemplary embodiment 1 of the present invention is described below. FIG. 1 is a block diagram illustrating a structure of the video image recording apparatus according to the exemplary embodiment 1. The video image recording apparatus includes an image pickup device 101, an image encoding processor 102, a recorder 103 for recording data in a recording medium 104, a cue position generator 105, and a management information storage 106. In the video image recording apparatus, at least the mage encoding processor 102, recorder 103, and cue position generator 105 may include a semiconductor integrated circuit.

The image pickup device 101 includes, for example, an imaging optical system equipped with a zoom-adjustable (capable of adjusting an angle of view) zoom lens, an imaging device (including a photoelectric conversion device which converts optical information obtained by the imaging optical system into an electrical signal such as CCD or CMOS), and an image signal processor for converting the electrical signal outputted from the imaging device into a digital video signal and then digitally processing the digital video signal.

The image encoding processor 102 applies a compression encoding process to the digital video signal obtained by the image pickup device 101 using a predefined method. Examples of the compression encoding method are MPEG2-Video, and MPEG4-AVC/H.264 (hereinafter, called MPEG). The MPEG encodes data per unit called GOP (Group Of Pictures) having a plurality of frames obtained by inserting intra-frame encoded I pictures at the intervals of a given number of frames.

There are two different GOPs; OpenGOP in which inter-frame prediction on GOP boundary is approved, and ClosedGOP in which inter-frame prediction on GOP boundary is forbidden. The OpenGOP depends on other GOPs including a reference frame, and it requires the reference GOP to randomly access the MPEG data. On the other hand, the ClosedGOP which is independent from any other GOP is advantageous for random accesses. In the OpenGOP, random accesses can be made when BrokenLink flag is set, however, any frame currently forward referenced cannot be reproduced, which results in image deterioration. The ClosedGOP, in which inter-frame prediction is forbidden on GOP boundary, is more likely to deteriorate in the encoding efficiency, as compared to the OpenGOP. In the present exemplary embodiment, the structure of GOP while an image is being captured is set to ClosedGOP to start the imaging operation and thereafter set to OpenGOP (however, reset to ClosedGOP whenever a predefined action is detected).

The recorder 103 writes video image encoded data obtained by the image encoding processor 102 in the recoding medium 104 at the intervals of a given unit. The recorder 103 keeps management information for management of the video image encoded data in the management information storage 106 such as a memory. The recorder 103 then reads the management information from the management information storage 106, and then writes the read management information along with the video image encoded data in the recording medium 104. Though the exemplary embodiment 1 does not particularly refer to audio data, the video image encoded data and audio data, if there is any audio data, are multiplexed in the recorder 103, and time stamps for synchronizing these data are imparted to the respective data. Examples of the recording medium 104 are HDD, SD card, and optical disc (DVD or BD).

The cue position generator 105 includes a first processor 105a and a second processor 105b. The first processor 105a detects a predefined action of the image pickup device 101 while the recorder 103 is recording the video image encoded data obtained by the image encoding processor 102 in the recording medium 104. The second processor 105b instructs the image encoding processor 102 to change the GOP structure on the basis of the predefined action detected by the first processor 105a. The cue position generator 105 according to the exemplary embodiment 1 detects a zoom-in operation of the zoom lens provided in the image pickup device 101 (adjustment of the angle of view to a smaller degree) or a zoom-out operation (adjustment of the angle of view to a larger degree) as the predefined action during the imaging operation, and instructs the image encoding processor 102 to change the GOP structure from OpenGOP to ClosedGOP based on the detected predefined action. The zoom-in operation or the zoom-out operation is detected by detecting a signal in accordance with the zoom operation transmitted from the image pickup device 101. The predefined action of the image pickup device 101 detected by the first processor 105a is preferably the zoom-in operation or the zoom-out operation which are the examples of image enlargement (smaller angle of view) and image reduction (larger angle of view).

An image can be captured by the image pickup device 101 in variously different manners, for example, telephoto imaging (imaging at a narrower angle of view), wide angle imaging (imaging at a wider angle of view), imaging in a high luminance level, imaging in a low luminance level, and imaging with variable contrast. The predefined action of the image pickup device 101 detected by the first processor 105a is not necessarily limited to the angle of view adjustments but may be a different action.

In the exemplary embodiment 1, the second processor 105b determines whether a given period of time passed after instructing the image encoding processor to change the GOP structure based on the detection result obtained by the first processor 105a. Having determined that the given period of time passed, the second processor 105b instructs the image encoding processor to change the GOP structure back to its original structure.

According to another mode of the present exemplary embodiment, the second processor 105b may instruct the image encoding processor 102 to generate a chapter display image based on the detection result obtained by the first processor 105a, instruct the recorder 103 to spit the video image encoded data based on the detection result obtained by the first processor 105a of the cue position generator 105, or instruct the image encoding processor 102 to add information of the predefined action in the image pickup device 101 to the video image encoded data based on the detection result detection result obtained by the first processor 105a of the cue position generator 105. These instructions may be combined and carried out.

The management information recorded in the management information storage 106 is data to be recorded in the recording medium 104 by the recorder 103 along with the video image encoded data, which includes such information as time stamps of the video image encoded data.

Next, a description is given to the following operation of the cue position generator 105 according to the exemplary embodiment 1. The operation described below includes processing steps to adjust the angle of view in the image pickup device 101 and then instruct the image encoding processor 102 to change the GOP structure.

A video image recording method for recording the video image data in the recording medium in the operation includes:
an image capturing step for capturing an image using the image pickup device 101 to obtain the digital video signal;
an image encoding step for encoding the digital video signal obtained in the image capturing step using the image encoding processor 102 to generate the video image encoded data;
a recording step for recording the video image encoded data in the recording medium 104 using the recorder 103.

The method further includes the following steps carried out by the cue position generator 105:
a first processing step for detecting the predefined action taking place in the image pickup device 101 when the video image encoded data is being recorded in the recording medium 104 in the recording step (adjustment of the angle of view in the present exemplary embodiment) and
a second processing step for instructing the image encoding processor 102 to change the GOP structure on the basis of the predefined action detected in the first processing step.

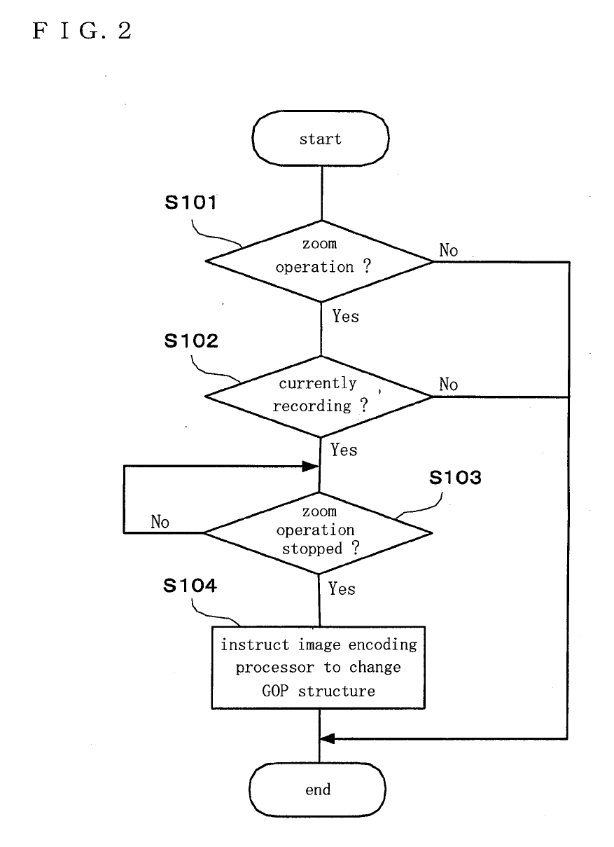

FIG. 2 is a flow chart illustrating an operation flow of the cue position generator 105 which performs the first and second processing steps. The cue position generator 105 determines whether the zoom-in operation or the zoom-out operation of the zoom lens in the image pickup device 101 (hereinafter, simply called zoom operation) is carried out (S101). Having determined in S101 that the zoom operation was not carried out (NO), the cue position generator 105 does not instruct the image encoding processor 102 to change the GOP structure. Having determined in S101 that the zoom operation was carried out (YES), the cue position generator 105 determines whether the image encoding processor 102 is currently compression-encoding the digital video signal (obtained by the image pickup device 101) (S102). Having determined in S102 that the image encoding processor 102 is not currently compression-encoding the digital video signal (NO), the cue position generator 105 does not instruct the image encoding processor 102 to change the GOP structure. Having determined that the compression encoding is currently ongoing (YES), the cue position generator 105 determines whether the zoom operation of the image pickup device 101 stops (S103). Having determined in S103 that the zoom operation did not stop, the cue position generator 105 determines again whether the zoom operation stops (S103), and repeats the processing step of S103 until the zoom operation actually stops.

Having determined in S103 that the zoom operation of the image pickup device 101 stopped, the cue position generator 105 instructs the image encoding processor 102 to change the GOP structure from OpenGOP to ClosedGOP (S104). The image encoding processor 102 changes the GOP structure of the video image encoded data from OpenGOP to ClosedGOP as instructed by the cue position generator 105.

When a given period of time passed after instructing the image encoding processor 102 to change the GOP structure from OpenGOP to ClosedGOP, the cue position generator 105 instructs the image encoding processor 102 to change the GOP structure back to OpenGOP from ClosedGOP. In the exemplary embodiment 1 wherein one ClosedGOP is inserted, the given period of time is set to approximately 0.5 second.

In the exemplary embodiment 1, the cue position generator 105 outputs the instruction of GOP structural change on the basis of the detected zoom operation of the zoom lens in the image pickup device 101, however, the GOP structural change may be instructed when an action other than the zoom operation is detected. For example, some digital video cameras are equipped with an acceleration sensor 120 (illustrated in FIG. 1) capable of detecting camera tilt to avoid such an event that the camera currently rolling is accidentally pointed downward and capture the image of ground. When the tilt detected by the acceleration sensor 120 reaches a given value in such a digital video camera, the imaging operation is forced to stop. This is rather inconvenient because the imaging operation stops even when the camera is intentionally pointed downward. Therefore, the camera tilt detecting feature should be turned off to obtain an image of an object located vertically downward, such as ground.

When the present invention is applied to these digital video cameras, the cue position generator 105 detects a tilt value detected by the acceleration sensor 120 in place of detecting the zoom operation of the zoom lens in the image pickup device 101, and the cue position generator 105 then changes the GOP structure based on the detected tilt value. When the camera is pointed vertically downward, for example, the cue position generator 105 detects where the image pickup device 101 is directed toward based on the detected tilt value outputted from the acceleration sensor 120 and determines a scene when the action took place as the cue position, and then changes the GOP structure from OpenGOP to ClosedGOP. When the camera face looking vertically downward is raised again in parallel with the horizontal direction, the cue position generator 105 detects the direction of the image pickup device 101 based on a tile value then output from the acceleration sensor 120, determines a scene when the action took place as the cue position, and then changes the GOP structure from OpenGOP to ClosedGOP.

As a result of the GOP structural change, a user can easily delete any of the scenes he find unnecessary. The time information of the position where the GOP structure is changed to ClosedGOP may be recorded in the management information storage 106 if instructed to do so by the cue position generator 105.

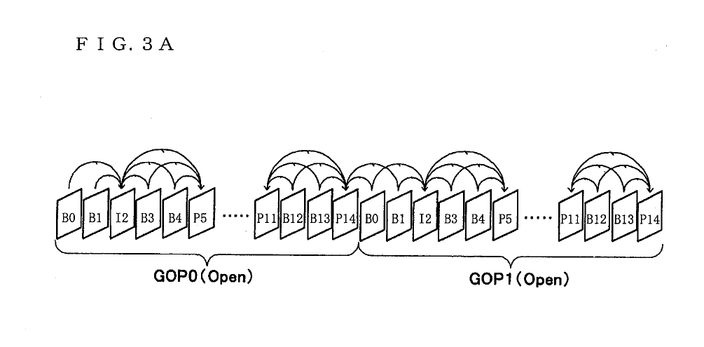

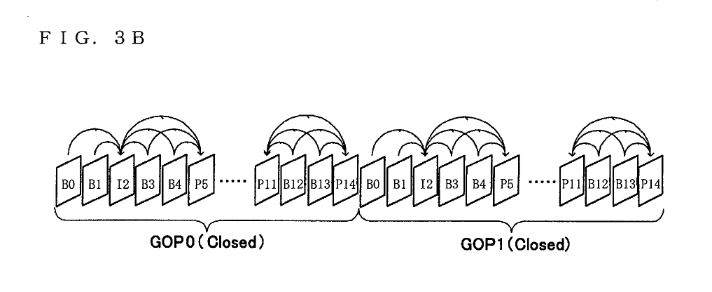

FIGS. 3A and 3B are drawings which respectively illustrate the GOP structure. FIG. 3A illustrates the structure of OpenGOP where inter-GOP forward prediction is performed. FIG. 3B illustrates the structure of ClosedGOP where inter-GOP prediction is not performed. In these drawings, I denotes an intra-frame encoded image (I-Picture), P denotes a forward-prediction encoded image (P-Picture), B denotes a bidirectional prediction image (B-picture), and arrows in the drawings denote reference images referenced by the encoded image.

When reproduction starts from, for example, GOP1 in the OpenGOP illustrated in FIG. 3A, B-Pictures preceding I-Picture in GOP1 are referencing GOPO, making it difficult to decode the video data. When reproduction starts from, for example, GOP1 in the ClosedGOP illustrated in FIG. 3, however, B-Pictures preceding I-Picture in GOP1 do not reference GOPO, succeeding in correctly decoding the video data.

In editing, it results in failure to decode the video data in the OpenGOP illustrated in FIG. 3A to delete GOPO because B-Pictures preceding I-Picture in GOP1 are referencing GOPO. As a result, the image quality is deteriorated. On the other hand, there is no risk of deteriorating the image quality when GOPO is deleted in the ClosedGOP illustrated in FIG. 3B because B-Pictures preceding I-Picture in GOP1 are not referencing GOPO.

As is clearly known from the description, it comes easier to cue any desirable scene when the GOP structure is changed from OpenGOP to ClosedGOP based on the detected cue position of the scene. Another advantage is to facilitate editing, for example, deleting the GOP ahead of the cue position.

As described so far, according to the exemplary embodiment 1, the user detects whether the zoom operation such as zoom in or zoom out of the image pickup device 101 and thereby detects the cue position of any wanted scene, and then changes the GOP structure of the detected cue position of the scene to ClosedGOP. The technical advantage of the present exemplary embodiment 1 makes it easier to quickly jump to any desirable scene to be reproduced or cue the scene, making it unnecessary to use the reference GOP. As a result, any unnecessary data transfer can be omitted, and the image quality can be prevented from deteriorating.

### Exemplary Embodiment 2

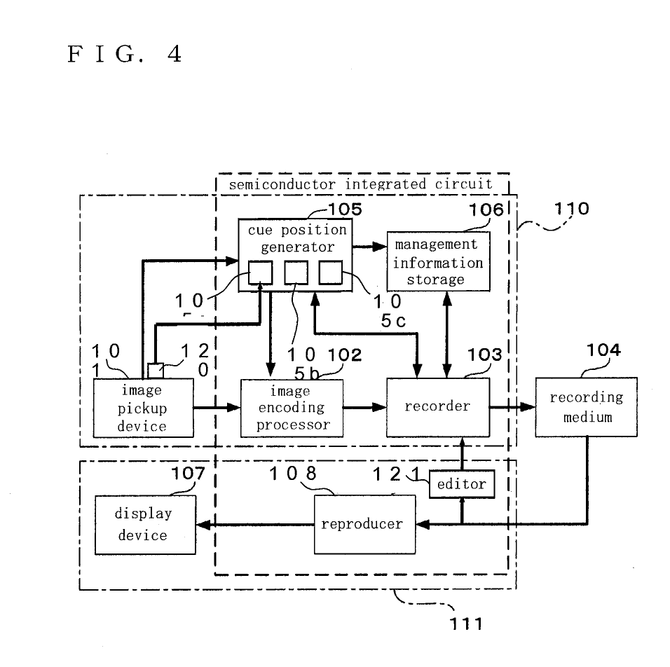

A video image recording and reproducing apparatus according to an exemplary embodiment 2 of the present invention is described below referring to the drawings. FIG. 4 is a block diagram illustrating a structure of the video image recording and reproducing apparatus according to the exemplary embodiment 2. The video image recording and reproducing apparatus is an apparatus where a video image recording apparatus 110 structurally similar to the apparatus according to the exemplary embodiment 1 and a video image reproducing apparatus 111 are integrally combined. According to another mode of the present exemplary embodiment, the video image recording apparatus 110 may be omitted to provide just the video image reproducing apparatus.

The video image recoding and reproducing apparatus according to the present exemplary embodiment includes an image pickup device 101, an image encoding processor 102, a recorder 103 for recording data in a recording medium 104, a cue position generator 105, a management information storage 106, a display device 107, and a reproducer 108. Of these structural elements, at least the mage encoding processor 102, recorder 103, cue position generator 105, and reproducer 108 includes a semiconductor integrated circuit. The video image reproducing apparatus 111 is provided with an editor 121 which detects whether variation of a predefined image characteristic quantity in video image encoded data is at least a given value, and sets a cue position based on a result of the detection.

The image pickup device 101 includes, for example, an imaging optical system equipped with a zoom-adjustable zoom lens, an imaging device (including a photoelectric conversion device which converts optical information obtained by the imaging optical system into an electrical signal such as CCD or CMOS), and an image signal processor for converting the electrical signal outputted from the imaging device into a digital video signal and then digitally processing the digital video signal.

The image encoding processor 102 applies a compression encoding process to the digital video signal obtained by the image pickup device 101 using a predefined method. Examples of the compression encoding method are MPEG2-Video, and MPEG. The MPEG encodes data per unit called GOP. In the present exemplary embodiment, the structure of GOP while an image is being captured is set to ClosedGOP to start the imaging operation and thereafter set to OpenGOP (however, reset to ClosedGOP whenever a predefined action is detected).

The recorder 103 writes the video image encoded data obtained by the image encoding processor 102 in the recoding medium at the intervals of a given unit. The recorder 103 keeps management information for management of the video image encoded data in the management information storage 106 such as a memory. The recorder 103 then reads the management information from the management information storage 106, and then writes the read management information along with the video image encoded data in the recording medium 104. Though the exemplary embodiment 1 does not particularly refer to audio data, the video image encoded data and audio data, if there is any audio data, are multiplexed in the recorder 103, and time stamps for synchronizing these data are imparted to the respective data. Examples of the recording medium 104 are HDD, SD card, and optical disc (DVD or BD).

The cue position generator 105 includes a first processor 105a, a second processor 105, and a third processor 105c. The first processor 105a detects a predefined action of the image pickup device 101 while the recorder 103 is recording the video image encoded data obtained by the image encoding processor 102 in the recording medium 104. The second processor 105b instructs the image encoding processor 102 to change the GOP structure on the basis of the predefined action detected by the first processor 105a. The cue position generator 105 according to the exemplary embodiment 2 detects the zoom-in or zoom-out operation of the zoom lens provided in the image pickup device 101 as the predefined action during the imaging operation, and instructs the image encoding processor 102 to change the GOP structure from OpenGOP to ClosedGOP based on the detected predefined action. The third processor 105c controls recording of time information of the cue position obtained from the recorder 103 in the management information storage 106 based on a processing result obtained by the second processor 105b.

The second processor 105b instructs the image encoding processor 102 to add the predefined action of the image pickup device 101 to the video image encoded data as additional information on the basis of the predefined action detected by the first processor 105a. In the present exemplary embodiment 2, the predefined action is the zoom operation of the image pickup device 101. The second processor 105b controls the image encoding processor 102 so that information of the zoom operation is added to a user data region in a header of the video image encoded data in the compression encoding process as user data. The management information is data to be recorded in the recording medium 104 along with the image encoded data, including information such as generally called time stamps of the image encoded data. An example of the display device 107 is a liquid crystal monitor. The reproducer 108 reads the additional information of the video image encoded data from the recording medium 104 and analyzes the read additional information, and then reads and reproduces the video image encoded data based on an analysis result thereby obtained. Having confirmed that information of the predefined information during the imaging operation is recorded in the additional information, the reproducer 108 can start reproduction at a position where the predefined action took place out during the imaging operation. Thus, the reproducer 108 can function as a reader and a reproducer both.

In the case where the zoom operation information of the image pickup device 101 during the imaging operation is additionally recorded in the recording medium 104 as information of the predefined action, the reproducer 108 can start reproduction at a position where the zoom operation ended (or started) in the zoom operation information.

The editor 121 can set a data position where variation of an image characteristic quantity in the video image encoded data is at least a given value as the cue position in the video image encoded data. The image characteristic quantity represents parameterized dimensions, positions and relative positions of parts of a face such as eyes, nose and mouth, and a face contour that can be extracted from an image, and a face contour. For example, a person in a video image is recognized as a photographic subject using, for example such a conventional face detection technique that parts of a face having distinguishable shapes such as eyes, nose and mouth are searched in the video image at around a screen center to detect whether there is a high degree of similarity. Then, a scene involving the person can be set as the cue position.

Next, a description is given to the following operation carried out by the cue position generator 105 according to the exemplary embodiment 2. The operation described below includes processing steps to detect the zoom operation of the image pickup device 101 and then instruct the image encoding processor 102 to change the GOP structure, and also issue the instruction to add the zoom operation information of the image pickup device 101 to the user data region in the header of the video image encoded data as user data.

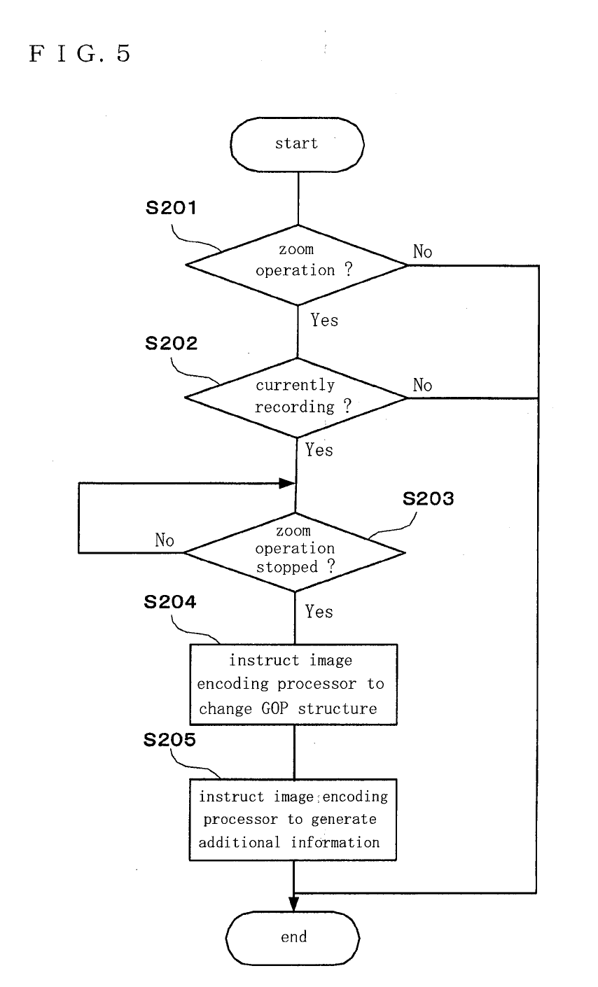

FIG. 5 is a flow chart illustrating an operation flow of the cue position generator 105. First, the cue position generator 105 determines whether the zoom-in operation or the zoom-out operation of the zoom lens (hereinafter, simply called zoom operation) in the imaging pickup device 101 is carried out (S201). Having determined in S201 that the zoom operation was not carried out (NO), the cue position generator 105 does not instruct the image encoding processor 102 to change the GOP structure. Having determined in S201 that the zoom operation was carried out (YES), the cue position generator 105 determines whether the image encoding processor 102 is currently compression-encoding the digital video signal (obtained by the image pickup device 101) (S202). Having determined in S202 that the image encoding processor 102 is not currently compression-encoding the digital video signal (NO), the cue position generator 105 does not instruct the image encoding processor 102 to change the GOP structure. Having determined in S202 that the image encoding processor 102 is currently compression-encoding the digital video signal (YES), the cue position generator 105 determines whether the zoom operation stops (S203). Having determined in S203 that the zoom operation did not stop (NO), the cue position generator 105 determines again whether the zoom operation stops (S203), and thereafter repeats the processing step of S203 until the zoom operation stops.

Having determined in S203 that the zoom operation stopped (YES), the cue position generator 105 instructs the image encoding processor 102 to change the GOP structure from OpenGOP to ClosedGOP (S204). Further, the cue position generator 105 instructs the image encoding processor 102 to add that the zoom operation of the image pickup device 101 was carried out to the video image encoded data as additional information (S205). The image encoding processor 102 changes the GOP structure from OpenGOP to ClosedGOP as requested by the cue position generator 105, and sets a zoom operation execution flag in the user data region in the header of the video image encoded data.

When a given period of time passed after instructing the image encoding processor 102 to change the GOP structure from OpenGOP to ClosedGOP, the cue position generator 105 instructs the image encoding processor 102 to change the GOP structure back to OpenGOP from ClosedGOP. In the exemplary embodiment 2 wherein one ClosedGOP is inserted, the given period of time is set to approximately 0.5 second.

In the exemplary embodiment 2, the cue position generator 105 may instruct the GOP structural change in response to detection of any other action (for example, the tilt of the image pickup device 101 detected by the acceleration sensor 120).

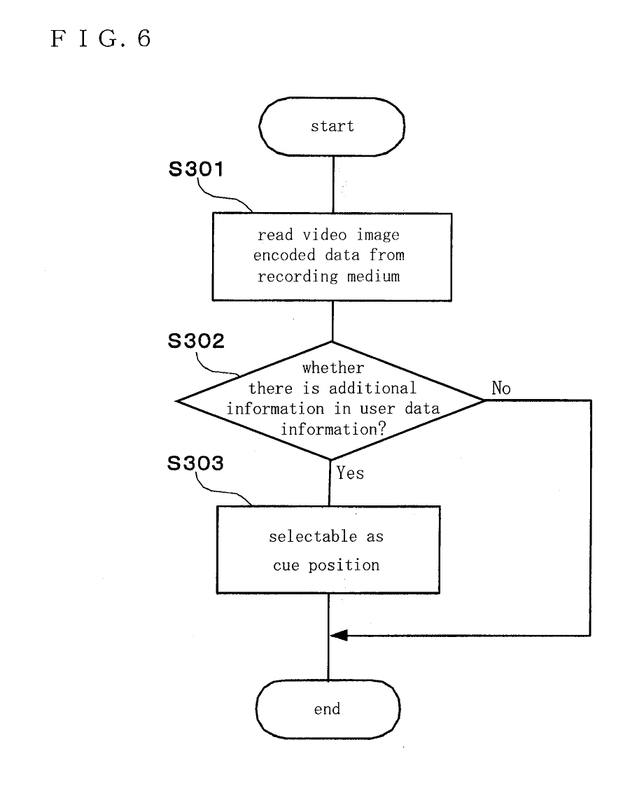

Referring to FIG. 6, a description is given to processing step carried out by the reproducer 108 to read the video image encoded data from the recording medium 104, reproduce the read video image encoded data, and output the reproduced video image encoded data to the display device 107. FIG. 6 is a flow chart illustrating an operation flow of the reproducer 108.

The reproducer 108 reads the video image encoded data from the recording medium 104 (S301). Then, the reproducer 108 analyzes the header (additional information) of the video image encoded data read from the recording medium 104 to determine whether the zoom operation execution flag of the zoom lens in the imaging operation is set in the user data region provided in the header (S302). Having determined in S302 that the zoom operation execution flag is set in the user data region, the reproducer 108 sets a particular scene in the user data region to be selectable as the cue position (S303). The scene can be selectable as the cue position through, for example, thumbnail display. When the video image recording and reproducing apparatus is instructed by the user to reproduce any desirable scene that can be now selected as the cue position, the video image encoded data in which the particular scene in the user data region is set as the cue position is outputted to the display device 107 in response to the instruction. Having determined in S302 that the zoom operation execution flag was not set in the user data region, there is no particular processing step to be carried out by the reproducer 108.

As described so far, according to the exemplary embodiment 2, when the user carries out the zoom operation such as zoom in or zoom out of the image pickup device 101, the GOP structure of any relevant scene is changed to ClosedGOP, and the zoom operation information is added to the header of the video image encoded data as additional information. Therefore, the scene which was zoomed during the imaging operation is reckoned as the cue position in reproduction to quickly jump to the wanted scene or cue the video image encoded data. Another advantage is to use no reference GOP, omitting any unnecessary data transfer and preventing the image quality from deteriorating.

So far were described the video image recoding apparatus and the video image reproducing apparatus according to the present invention based on the exemplary embodiments. However, the present invention is not necessarily limited to the exemplary embodiments. The exemplary embodiments can be variously modified by the ordinarily skilled in the art, or the structural elements described in the different embodiments can be combined as far as such modification and combination stay within the scope of the technical idea to be achieved by the present invention.

### INDUSTRIAL APPLICABILITY

The present invention can be applied to video image recording and reproduction apparatuses, particularly to electronic apparatuses in general equipped with an image capturing feature such as digital video camera and mobile telephone.

### DESCRIPTION OF REFERENCE SYMBOLS

101 image pickup device
102 image encoding processor
103 recorder
104 recording medium
105 cue position generator
106 management information
107 display device
108 reproducer

What is claimed is:

1. A video image recoding apparatus comprising:
an image pickup device for capturing an image to obtain a digital video signal;
an image encoding processor for encoding the digital video signals for each GOP having a plurality of frames to generate video image encoded data;
a recorder for recording the video image encoded data in a recording medium; and
a cue position generator, wherein
the cue position generator comprises:
a first processor for detecting a predefined action taking place in the image pickup device when the recorder is recording the video image encoded data in the recording medium; and
a second processor for instructing the image encoding processor to change a GOP structure in the video image encoded data on the basis of the predefined action detected by the first processor.

2. The video image recoding apparatus as claimed in claim 1, wherein
the second processor instructs the video image encoding processor to change the GOP structure in the video image encoded data from OpenGOP to ClosedGOP.

3. The video image recoding apparatus as claimed in claim 1, wherein
the image pickup device can adjust an imaging angle of view, and the first processor detects the adjustment of the imaging angle of view by the image pickup device as the predefined action.

4. The video image recoding apparatus as claimed in claim 1, wherein
the second processor instructs the image encoding processor to undo the GOP structural change in a certain period of time passes after instructing the image encoding processor to change the GOP structure.

5. The video image recoding apparatus as claimed in claim 1, wherein
the second processor instructs the image encoding processor to generate a chapter display image on the basis of the predefined action detected by the first processor.

6. The video image recoding apparatus as claimed in claim 1, wherein
the second processor instructs the recorder to split the video image encoded data on the basis of the predefined action detected by the first processor.

7. The video image recoding apparatus as claimed in claim 1, wherein
the second processor instructs the image encoding processor to add information relating to the predefined action to the video image encoded data as additional information on the basis of the predefined action detected by the first processor.

8. The video image recoding apparatus as claimed in claim 1, further comprising a sensor for detecting tilt of the image pickup device, wherein the first processor detects the tilt of the image pickup device as the predefined action on the basis of a sensor output obtained from the sensor.

9. The video image recoding apparatus as claimed in claim 1, further comprising a management information recorder for recording therein management information used to manage the video image encoded data, wherein
the cue position generator further comprises a third processor, the third processor obtaining information indicating a data position of the video image encoded data where the GOP structural change is made by the second processor from the recorder, and records the obtained information as the management information in the management information recorder.

10. A video image reproducing apparatus comprising:
a reader for reading additional information of video image encoded data from a recording medium; and
a reproducer for reading the video image encoded data from the recording medium based on the additional information to reproduce the read video image encoded data, wherein
the reproducer determines whether information relating to a predefined action taking place when the video image encoded data is obtained is recorded in the additional information read by the reader, and the reproducer which determined that the information is recorded in the additional information can reproduce the video image encoded data from a data position defined as a position where the predefined action took place in the information.

11. The video image reproducing apparatus as claimed in claim 10, wherein
the predefined action is adjustment of an angle of view by the imaging pickup device which captures a digital video signal constituting the video image encoded data.

12. The video image reproducing apparatus as claimed in claim 10, further comprising an editor which can set a data position in the video image encoded data where variation of an image characteristic quantity is at least a given quantity as a cue position in the video image encoded data.

13. A video image recording method comprising:
an image capturing step for capturing an image using an image pickup device to obtain a digital video signal;
an image encoding step for encoding the digital video signals for each GOP having a plurality of frames using an image encoding processor to generate video image encoded data;
a recording step for recording the video image encoded data in a recording medium using a recorder; and
a cue position generating step, wherein
the cue position generating step comprises:
a first processing step for detecting a predefined action taking place in the image pickup device when the video image encoded data is being recorded in the recording medium in the recording step; and
a second processing step for instructing the image encoding processor to change a GOP structure on the basis of the predefined action detected in the first processing step.

14. The video image recording method as claimed in claim 13, wherein
the imaging pickup device can adjust an imaging angle of view, and the first processing step detects the adjustment of the imaging angle of view by the image pickup device as the predefined action.

15. A video image reproducing method comprising:
a reading step for reading additional information of video image encoded data from a recording medium where the video image encoded data including the additional information is recorded; and
a reproducing step for reading the video image encoded data from the recording medium based on the additional information read in the reading step to reproduce the read video image encoded data, wherein
the reproducing step determines whether information relating to a predefined action taking place when the video image encoded data is obtained is recorded in the additional information read in the reading step, and the video image encoded data can be reproduced from a data position defined as a position where the predefined action took place in the information when the reproducing step determined that the information is recorded in the additional information.

16. The video image reproducing method as claimed in claim 15, wherein
the predefined action is adjustment of an imaging angle of view by the imaging pickup device which captures a digital video signal constituting the video image encoded data.

17. A semiconductor integrated circuit, comprising:
an image encoding processor connected to an external image pickup device, the image encoding processor encoding digital video signals for each GOP having a plurality of frames to generate video image encoded data;
a recorder connected to an external recording medium to record the video image encoded data in the recording medium; and
a cue position generator, wherein
the cue position generator comprises:
a first processor for detecting a predefined action taking place in the image pickup device when the recorder is recording the video image encoded data in the recording medium; and
a second processor for instructing the image encoding processor to change a GOP structure in the video image encoded data on the basis of the predefined action detected by the first processor.
